(19) United States
(12) Patent Application Publication
(10) Pub. No.: US 2007/0298794 A1
(43) Pub. Date: Dec. 27, 2007

(54) METHOD AND SYSTEM FOR REGISTERING USER EQUIPMENT WITH COMMUNICATION NETWORK

(75) Inventor: Song Rae CHO, Kyunggi-do (KR)

Correspondence Address: LEE, HONG, DEGERMAN, KANG & SCHMADEKA, 660 S. FIGUEROA STREET, Suite 2300, LOS ANGELES, CA, 90017, US

(73) Assignee: LG Electronics Inc.

(21) Appl. No.: 11/766,743

(22) Filed: Jun. 21, 2007

(30) Foreign Application Priority Data
Jun. 23, 2006 (KR) 10-2006-0057071

(51) Int. Cl. H04Q 7/20

(52) U.S. Cl. 455/435.1

(57) ABSTRACT

The present invention is related to registering a user equipment (UE) with a communication network. The present invention comprises registering a UE with a communication network by transmitting a registration request message to the communication network and receiving a registration response message from the communication network, wherein the registration response message comprises information related to a registration validity period. A session initiation protocol (SIP) message is then transmitted to the communication network, wherein the UE is re-registered with the communication network if the SIP message is received by the communication network before the expiration of the registration validity period.

### CROSS-REFERENCE TO RELATED APPLICATIONS

Pursuant to 35 U.S.C. § 119(a), this application claims the benefit of earlier filing date and right of priority to Korean Application No. 10-2006-0057071, filed on Jun. 23, 2006, the contents of which are hereby incorporated by reference herein in their entirety.

### FIELD OF THE INVENTION

The present invention relates to registering a user equipment (UE) with a communication network, and more particularly, to re-registering the UE using a session initiation protocol (SIP) message.

### BACKGROUND OF THE INVENTION

An Internet Protocol Multimedia Subsystem (IMS), introduced in 3rd Generation Partnership Project (3GPP) Release 5, is an open architecture for enabling Internet Protocol (IP) multimedia services in various environments such as mobile, wired, and convergence environments. The IMS is a core technology for providing new services in an all IP-based next-generation communication environment. The IMS is based on Internet Engineering Task Force (IETF) protocols and is independent of radio access networks such as Enhanced Data rates for Global Evolution (EDGE), Wideband Code Division Multiple Access (WCDMA), High Speed Downlink Packet Access (HSDPA), Institute of Electrical and Electronics Engineers (IEEE) 802.11a/b/g, and Wibro networks. The IMS uses an IETF session initiation protocol (SIP) for signaling between a user equipment (UE) and a core network.

Registration of the UE with an IMS network is necessary for properly routing SIP messages to the UE and involves registering the IP address and location of the UE with the IMS network. Once the UE has successfully registered with the IMS network, the registration is valid for a registration validity period. In order to maintain its registration with the IMS network, the UE must perform a re-registration operation before the expiration of the registration validity period.

FIG. 1 explains the registration of a UE with a typical IMS network. Referring to FIG. 1, a registration validity period is set to 3600 seconds. Accordingly, the UE must perform a registration transaction, independent of an SIP transaction, before the expiration of the registration validity period in order re-register with the IMS network. If the UE fails to perform a re-registration transaction within the registration validity period, the registration of the UE with the IMS network may be cancelled.

Hence, the UE maintains its registration with the IMS network by performing a registration transaction. As a result of the registration transaction, the IMS network is notified that the UE can still be provided with IMS services and can transmit/receive signals to/from the IMS network. Therefore, if the UE performs no registration transaction within the registration validity period by transmitting, for example, a register message, the IMS network determines that the UE cannot transmit/receive signals to/from the IMS network.

Conventionally, the re-registration of the UE with the IMS network comprises performing a registration transaction that involves transmitting a register message by the UE. However, this is problematic because the re-registration of the UE with the IMS network requires transmitting the necessary registration transaction message regardless of whether the UE has performed or is currently performing an SIP transaction. Thus, unnecessary traffic exists.

### SUMMARY OF THE INVENTION

The present invention is directed to registering a user equipment (UE) with a communication network.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the present invention is embodied in a method of registering a user equipment (UE) with a communication network, the method comprising registering a UE with a communication network by transmitting a registration request message to the communication network and receiving a registration response message from the communication network, wherein the registration response message comprises information related to a registration validity period; and transmitting a session initiation protocol (SIP) message to the communication network, wherein the UE is re-registered with the communication network if the SIP message is received by the communication network before the expiration of the registration validity period.

Preferably, the UE is re-registered by extending the registration validity period. Preferably, the SIP message comprises a re-registration request.

Preferably, the UE registration is canceled if one of the SIP message and the re-registration message is not received by the communication network before the expiration of the registration validity period. Preferably, the communication network is an Internet Protocol Multimedia Subsystem (IMS) network.

Preferably, a communication network element having a call session control function re-registers the UE. Preferably, the UE is re-registered by extending the registration validity period based on registration request information included in the SIP message.

Preferably, the registration validity period is varied according to the registration request information. Preferably, the registration validity period is set differently for certain time periods of a day.

In accordance with another embodiment of the present invention, a method of registering a user equipment (UE) with a communication network comprises registering a UE with a communication network by receiving a registration request message from the UE and transmitting a registration response message to the UE, wherein the registration response message comprises information related to a registration validity period, receiving a session initiation protocol (SIP) message from the UE, and re-registering the UE with the communication network if the SIP message is received by the communication network before the expiration of the registration validity period.

Preferably, re-registering the UE comprises extending the registration validity period. Preferably, the SIP message comprises a re-registration request.

Preferably, the method further comprises canceling the UE registration if one of the SIP message and the re-registration message is not received by the communication network before the expiration of the registration validity period. Preferably, the communication network is an Internet Protocol Multimedia Subsystem (IMS) network.

Preferably, a communication network element having a call session control function re-registers the UE. Preferably, re-registering the UE comprises extending the registration validity period based on registration request information included in the SIP message.

Preferably, the registration validity period is varied according to the registration request information. Preferably, the registration validity period is set differently for certain time periods of a day.

In accordance with another embodiment of the present invention, a system for registering a user equipment (UE) with a network comprises a network having a network element, and a UE in communication with the network, wherein the UE registers with the network by transmitting a registration request message to the network element and receiving a registration response message from the network element, the registration response message comprising information related to a registration validity period, wherein the UE transmits a session initiation protocol (SIP) message to the network element, and the network element re-registers the UE with the network if the SIP message is received by the network element before the expiration of the registration validity period.

Preferably, the network element re-registers the UE by extending the registration validity period. Preferably, the SIP message comprises a re-registration request.

Preferably, the network element cancels the UE registration if one of the SIP message and the re-registration message is not received by the network element before the expiration of the registration validity period. Preferably, the network is an Internet Protocol Multimedia Subsystem (IMS) network.

Preferably, the network element comprises a call session control function. Preferably, the network element re-registers the UE by extending the registration validity period based on registration request information included in the SIP message.

Preferably, the registration validity period is varied according to the registration request information. Preferably, the registration validity period is set differently for certain time periods of a day.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. Features, elements, and aspects of the invention that are referenced by the same numerals in different figures represent the same, equivalent, or similar features, elements, or aspects in accordance with one or more embodiments.

FIG. 1 illustrates the registration of a user equipment (UE) with a typical Internet Protocol Multimedia Subsystem (IMS) network.

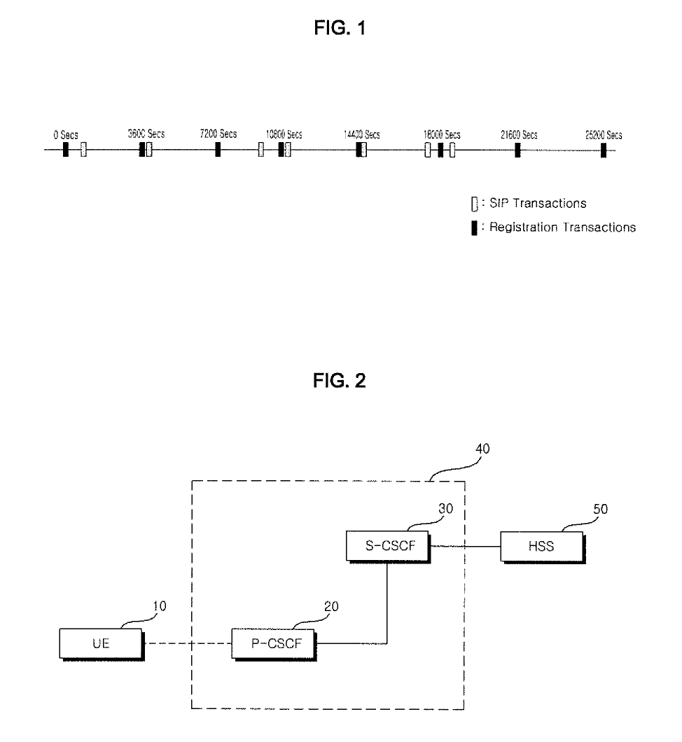

FIG. 2 illustrates a block diagram of an IMS network, wherein a method of controlling registration of the UE is applied in accordance with one embodiment of the present invention.

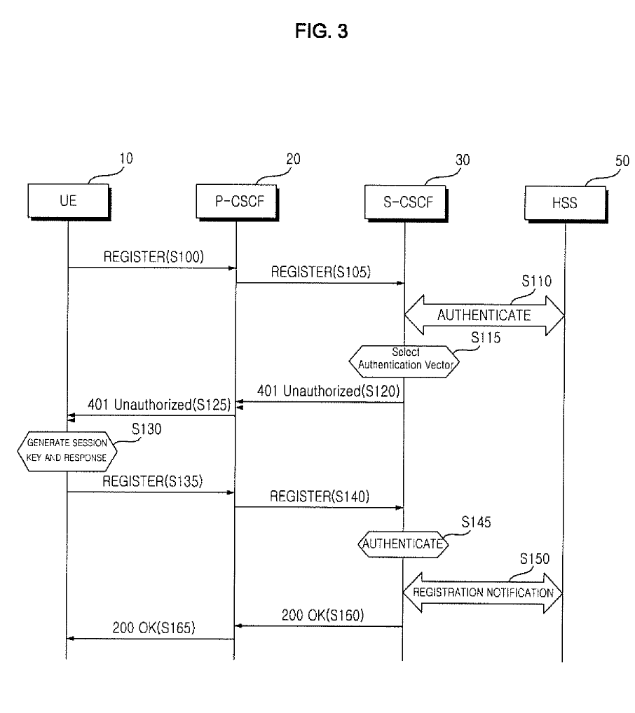

FIGS. 3 and 4 illustrate message sequence flowcharts for explaining a method of controlling registration of the UE in accordance with one embodiment of the present invention.

FIG. 5 illustrates a method of controlling registration of the UE in accordance with one embodiment of the present invention.

FIG. 6 illustrates a flowchart of a method of controlling registration of the UE in accordance with one embodiment of the present invention.

### DETAILED DESCRIPTION OF THE PREFERRED EMBODIMENTS

The present invention relates to controlling registration of a user equipment (UE) in a communication network. The present invention will hereinafter be described in detail with reference to the accompanying drawings in which exemplary embodiments of the invention are shown.

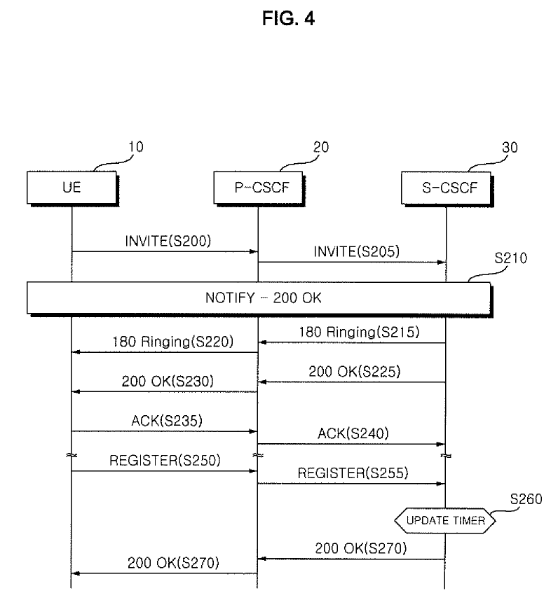

FIG. 3 illustrates a message sequence flowchart for explaining a method of controlling registration of the UE in accordance with one embodiment of the present invention. Referring to FIG. 3, the UE 10 issues a registration request by transmitting a register message to the P-CSCF 20 (S100). The P-CSCF 20 then transmits the register message transmitted by the UE 10 to the S-CSCF 30 (S105). The register message transmitted by the UE 10 may include information regarding a registration validity period desired by the UE 10.

The S-CSCF 30 performs authentication of the UE 10 along with the HSS 50 (S100). Preferably, the S-CSCF 30 selects an authentication vector for applying authentication (S115). The S-CSCF 30 then transmits a 401 unauthorized message including authentication information to the UE 10 via the P-CSCF 20 (S120, S125).

The UE 10 generates a session key and response message based on the 401 unauthorized message (S130). The UE 10 then transmits a register message to the S-CSCF 30 via the P-CSCF 20 using the authentication response (S135, S140).

Subsequently, the S-CSCF 30 authenticates the registration request issued by the UE 10 (S145). The S-CSCF 30 then notifies the HSS 50 of the registration of the UE 10 (S150). Afterward, the S-CSCF 30 responds to the UE 10 by transmitting a 200 OK message including information regarding a registration validity period determined by the S-CSCF 30 (S160, S165). Preferably, the registration validity period determined by the S-CSCF 30 is the same as or shorter than the registration validity period desired by the UE 10.

In this manner, the UE 10 can be registered with a network for the first time, and a registration validity period may be set for the UE 10. Here, the registration validity period is the term of validity of the registration of the UE 10 with the network. Preferably, the UE 10 will issue a re-registration request before the expiration of the registration validity period. If the UE 10 is successfully re-registered with the network before the expiration of the registration validity period, the registration validity period is extended.

FIG. 4 illustrates a message sequence flowchart for explaining the re-registration of the UE in accordance with one embodiment of the present invention. In FIG. 4, the UE 10 is assumed to have already been registered with a network through the process illustrated in FIG. 3.

Referring to FIG. 4, the UE 10 transmits an invite message to the P-CSCF 20 for initiating a call session (S200). The P-CSCF 20 then transmits the invite message to the S-CSCF 30 (S205). Once an SIP message such as the invite message is transmitted to the S-CSCF 30 by the UE 10, messages, such as NOTIFY and 200 OK, are transmitted between the UE 10 and the S-CSCF 30 (S210).

Preferably, an SIP message transmitted by the UE 10 includes information necessary for issuing a re-registration request. For example, an SIP message transmitted by the UE 10 may include an Expire header for setting a registration validity period. An Expire header of an SIP message, however, may be interpreted differently by different SIP methods. Therefore, a Registration Expire header may be additionally defined, and may be used exclusively for extending a registration validity period. Network elements such as the S-CSCF 30 may determine whether the UE 10 has issued a re-registration request based on header information of an SIP message transmitted by the UE 10.

After the transmission of the NOTIFY and 200 OK messages between the UE 10 and the S-CSCF 30, the UE 10 receives a 180 Ringing message (S215, S220) and a 200 OK message (S225, S230) from the S-CSCF 30 via the P-CSCF 20. In response, the UE 10 transmits an acknowledgement (ACK) message to the S-CSCF 30 via the P-CSCF 20 (S235, S240).

When the ACK message transmitted by the UE 10 is received, the S-CSCF 30 extends a registration validity period set for the UE 10 by updating a re-registration timer of the S-CSCF 30 which counts the registration validity period (S260). Preferably, the UE 10 updates a re-registration timer of the UE 10 when notified that an SIP message transmitted by the UE 10 is successfully received by the S-CSCF 30. Accordingly, when the UE 10 transmits an arbitrary SIP message to a network, the UE's registration validity period is extended to be the same as that of a network upon receiving a final response message regarding the result of a normal transaction from the network.

In this manner, the UE 10 maintains its registration with a network by performing a re-registration operation through an SIP transaction. Therefore, the generation of unnecessary traffic is prevented during the registration operation.

If no SIP messages are transmitted during the registration validity period set for the UE 10, the UE 10 may perform a typical re-registration transaction. More specifically, the UE 10 may transmit a register message to the S-CSCF 30 via the P-CSCF 20 before the expiration of the registration validity period set for the UE 10 (S250, S255). The S-CSCF 30 then updates the re-registration timer of the S-CSCF 30 (S260). Thereafter, the S-CSCF 30 transmits a 200 OK message to the UE 10 via the P-CSCF 20 (S270, S275), thereby notifying the UE 10 of the extension of the registration validity period set for the UE 10 and completing the re-registration of the UE 10.

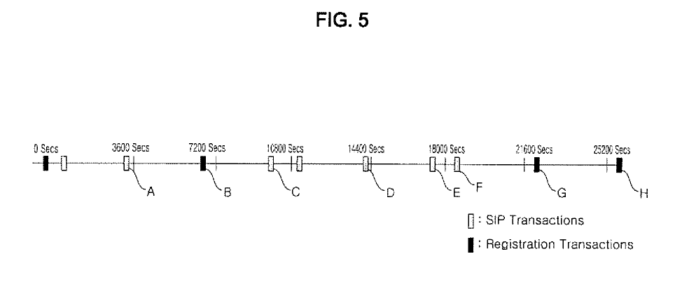

FIG. 5 illustrates controlling the re-registration of the UE in accordance with one embodiment of the present invention. Referring to FIG. 5, if a registration validity period is 3600 seconds long, the re-registration of the UE may be accomplished by performing an SIP transaction before the expiration of the registration validity period or by performing a typical re-registration transaction.

As shown in FIG. 5, the re-registration of the UE may be accomplished by an SIP transaction A, C, D, E, or F. If no SIP transaction is performed during the registration validity period, the re-registration of the UE may be accomplished by performing a typical registration transaction B, G or H.

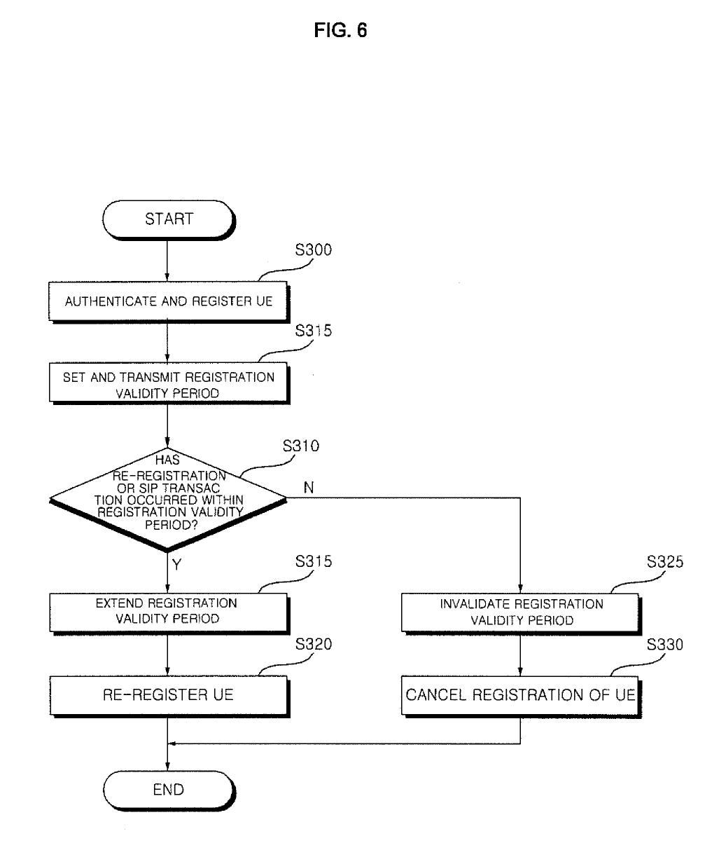

FIG. 6 illustrates a flowchart of a method of controlling registration of the UE in accordance with one embodiment of the present invention. Referring to FIG. 6, authentication and registration of the UE are initially performed (S300). Thereafter, a registration validity period is set for the UE, and information regarding the registration validity period is transmitted to the UE (S305). It is then determined whether a registration or SIP transaction has been performed by the UE within the registration validity period (S310).

If it is determined that a registration or SIP transaction has been performed by the UE within the registration validity period, the registration validity period is extended (S315). The UE is then re-registered (S320). However, if it is determined that neither a registration transaction nor an SIP transaction has been performed by the UE within the registration validity period, the registration validity period is invalidated (S325), and the registration of the UE is canceled (S330). Thus, even when no registration request is issued by the UE, the re-registration of the UE may be allowed according to whether an SIP transaction has been performed by the UE within a registration validity period of the UE.

In accordance with the present invention, a registration validity period may be set differently for different time periods of the day, thereby reducing the number of registration transactions during a certain time period of the day. For example, because the radius of movement of the UE is not large during the evening, the status of the UE regarding whether the UE can be provided with IMS services rarely changes at night. Therefore, a registration validity period of the UE may be set to be longer in the nighttime than in the daytime, thereby reducing the number of registration transactions.

In one aspect, the present invention can be realized as computer-readable code written on a computer-readable recording medium that can be read by processors such as Mobile Station Modem (MSM) chips. Examples of the computer-readable recording medium include a ROM, a RAM, a flash memory, a CD-ROM, a magnetic tape, a floppy disc, an optical data storage, and a carrier wave (e.g., data transmission through the Internet). The computer-readable recording medium can be distributed over a plurality of computer systems connected to a network so that computer-readable code is written thereto and executed therefrom in a decentralized manner.

As described above, according to the present invention, the number of registration transactions is reduced by performing the registration of the UE using an SIP message, rather than a register message. As a result, the probability of generating unnecessary wireless traffic is reduced, and thus provides the same effect as expanding network capacity from the viewpoint of a system. In addition, the number of registration transactions during the evening can be minimized by setting a registration validity period differently for a certain time periods of the day.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of registering a user equipment (UE) with a communication network, the method comprising:
registering a UE with a communication network by transmitting a registration request message to the communication network and receiving a registration response message from the communication network, wherein the registration response message comprises information related to a registration validity period; and
transmitting a session initiation protocol (SIP) message to the communication network, wherein the UE is re-registered with the communication network if the SIP message is received by the communication network before the expiration of the registration validity period.

2. The method of claim 1, wherein the UE is re-registered by extending the registration validity period.

3. The method of claim 1, wherein the SIP message comprises a re-registration request.

4. The method of claim 3, wherein the UE registration is canceled if one of the SIP message and the re-registration message is not received by the communication network before the expiration of the registration validity period.

5. The method of claim 1, wherein the communication network is an Internet Protocol Multimedia Subsystem (IMS) network.

6. The method of claim 1, wherein a communication network element having a call session control function re-registers the UE.

7. The method of claim 1, wherein the UE is re-registered by extending the registration validity period based on registration request information included in the SIP message.

8. The method of claim 7, wherein the registration validity period is varied according to the registration request information.

9. The method of claim 1, wherein the registration validity period is set differently for certain time periods of a day.

10. A method of registering a user equipment (UE) with a communication network, the method comprising:
registering a UE with a communication network by receiving a registration request message from the UE and transmitting a registration response message to the UE, wherein the registration response message comprises information related to a registration validity period;
receiving a session initiation protocol (SIP) message from the UE; and
re-registering the UE with the communication network if the SIP message is received by the communication network before the expiration of the registration validity period.

11. The method of claim 10, wherein re-registering the UE comprises extending the registration validity period.

12. The method of claim 10, wherein the SIP message comprises a re-registration request.

13. The method of claim 12, further comprising canceling the UE registration if one of the SIP message and the re-registration message is not received by the communication network before the expiration of the registration validity period.

14. The method of claim 10, wherein the communication network is an Internet Protocol Multimedia Subsystem (IMS) network.

15. The method of claim 10, wherein a communication network element having a call session control function re-registers the UE.

16. The method of claim 10, wherein re-registering the UE comprises extending the registration validity period based on registration request information included in the SIP message.

17. The method of claim 16, wherein the registration validity period is varied according to the registration request information.

18. The method of claim 10, wherein the registration validity period is set differently for certain time periods of a day.

19. A system for registering a user equipment (UE) with a network, the system comprising:
a network having a network element; and
a UE in communication with the network;
wherein the UE registers with the network by transmitting a registration request message to the network element and receiving a registration response message from the network element, the registration response message comprising information related to a registration validity period;
wherein the UE transmits a session initiation protocol (SIP) message to the network element, and the network element re-registers the UE with the network if the SIP message is received by the network element before the expiration of the registration validity period.

20. The system of claim 19, wherein the network element re-registers the UE by extending the registration validity period.

21. The system of claim 19, wherein the SIP message comprises a re-registration request.

22. The system of claim 21, wherein the network element cancels the UE registration if one of the SIP message and the re-registration message is not received by the network element before the expiration of the registration validity period.

23. The system of claim 19, wherein the network is an Internet Protocol Multimedia Subsystem (IMS) network.

24. The system of claim 19, wherein the network element comprises a call session control function.

25. The system of claim 19, wherein the network element re-registers the UE by extending the registration validity period based on registration request information included in the SIP message.

26. The system of claim 25, wherein the registration validity period is varied according to the registration request information.

27. The system of claim 19, wherein the registration validity period is set differently for certain time periods of a day.
